(19) United States
(12) Patent Application Publication
(10) Pub. No.: US 2025/0389700 A1
(43) Pub. Date: Dec. 25, 2025

(54) COUPLING UNIT FOR USE IN A GAS DISTRIBUTION NETWORK OF A GAS CHROMATOGRAPHY SYSTEM

(71) Applicant: Thermo Fisher Scientific S.p.A., Segrate MI (IT)

(72) Inventors: Massimo Gherlinzoni, Monza (IT); Tiziano Bosaglia, Seregno (IT); Federico Belvisi, Vercelli (IT); Stefano Pelagatti, Milano (IT); Riccardo Facchetti, Milano (IT)

(73) Assignee: Thermo Fisher Scientific S.p.A., Segrate MI (IT)

(21) Appl. No.: 18/879,659

(22) PCT Filed: Jun. 27, 2023
(86) PCT No.: PCT/EP2023/067453

§ 371 Date: Dec. 27, 2024

(30) Foreign Application Priority Data
Jul. 1, 2022 (GB) 2209694.5

(51) Int. Cl. G01N 30/60; G01N 30/02; G01N 30/32

(52) U.S. Cl. CPC G01N 30/606; G01N 30/32; G01N 2030/025; G01N 2030/328

(57) ABSTRACT

A coupling unit for coupling gas conduits in a gas distribution network comprises a base part and a module part. The base part comprises at least one base gas orifice, while the module part is provided with at least one module gas orifice, each module gas orifice matching a corresponding base gas orifice. Each base gas orifice is provided with a valve which is normally closed. A module gas orifice is configured for opening the valve of the corresponding base gas orifice when the base part and the module part are brought together. Each valve may comprise a movable valve element accommodated in a respective base gas orifice and a resilient element for keeping the valve normally closed.

### FIELD OF THE DISCLOSURE

The present disclosure relates to a gas distribution network and its components, for example a gas distribution network for analytical instruments, such as gas chromatography systems. More in particular, the present disclosure relates to a coupling unit for coupling gas conduits in a gas distribution network for analytical instruments.

### BACKGROUND OF THE DISCLOSURE

Systems for analytical chemistry, such as gas chromatography (GC) systems, are well known. A conventional gas chromatography system may comprise an analytical column, an oven in which the analytical column is arranged, an injector for introducing a sample to be analyzed into the inlet of the analytical column, and a detector connected to the exit of the analytical column to detect the eluate exiting from column. Gas conduits are typically provided to supply a carrier gas, one or more detector gases and optionally auxiliary gases.

US 2022/0011279 discloses carrier gas connection devices enabling to change the carrier gas provided to a gas chromatography channel. The carrier gas connection devices comprise a channel adaptor, a carrier block and a clamping system. This known system has the disadvantage that, when a channel adaptor is removed from a carrier block, the carrier block passageways are open and gas is spilled into the atmosphere.

It is often useful to be able to replace components of a gas chromatography system, for example to provide different injectors for different applications or to replace components for maintenance purposes. U.S. Pat. No. 8,871,149 discloses a gas chromatography system in which substitutable modules are provided, in particular injector modules and/or detector modules. Each module may be insertable in a seat of the gas chromatography system with fast connections of its electronic and pneumatic means to corresponding outlets. Gas tubing is provided between the gas connections to deliver several gases, such as a carrier gas, air, H₂ and any further gases. The entire contents of U.S. Pat. No. 8,871,149 are herewith incorporated by reference in this document.

When replacing or temporarily removing modules of a gas chromatography system, letting gas escape is generally undesirable. It is of course possible to manually close off the gas supply when modules are replaced or removed, and to manually re-open the gas supply afterwards, but this is time-consuming and prone to error. In particular when two or more gas chromatography systems are connected to the same gas conduit, closing off this gas conduit to replace a module in one of the systems will cause an undesired interruption in the other system(s).

### SUMMARY OF THE DISCLOSURE

The present disclosure provides a gas chromatography system comprising:
at least one gas distribution network,
at least one coupling unit, and
at least one gas chromatography unit.

The at least one coupling unit comprises a base part and a module part, the base part being connected to the at least one gas distribution network and the module part being connected to the at least one gas chromatography unit. The base part and the module part can be removably coupled, and the base part comprises at least one valve.

The module part is configured for operating the at least one valve, so as to automatically establish a gas connection when the base part and the module part are coupled, and automatically interrupt the gas connection when the base part and the module part are decoupled.

By providing a module part configured for operating the valve (or valves), the valve can be opened when the base part and the module part are brought together, thus establishing a gas connection, and the valve can automatically be closed when the base part and the module part are taken apart. That is, the removal of the module part can cause the valve to close.

In an embodiment, the base part comprises at least one base gas orifice, the module part comprises at least one module gas orifice, each module gas orifice matching a corresponding base gas orifice, each base gas orifice being provided with a respective valve which is normally closed, each module gas orifice being configured for opening the valve of the corresponding base gas orifice when the base part and the module part are brought together, each valve comprising a movable valve element accommodated in a respective base gas orifice and a resilient element for keeping the valve normally closed, and each valve element being at least partially hollow so as to provide a valve gas channel through the respective valve element.

By providing each base gas orifice with a respective valve which is normally closed, it is ensured that no gas can flow out of the base unit when no module is connected to it or when a module is removed. This removes the need to close off entire gas conduits. The action of the resilient elements closes the valves when the valves are not operated by the module part.

By providing module gas orifices that are configured for opening the valve of the corresponding base gas orifice when the base part and the module part are brought together, it is ensured that gas can flow through the matched orifices from the base part to the module part when the parts are brought together.

The movable element of a valve is thus configured for opening and closing the valve, the at least one resilient element keeping the valve normally closed. Bringing together the module part and the base part, for example by placing the module part on the base part, can cause a module gas orifice to open a valve. Removing the module part from the base part causes the valve to close.

By providing a movable valve element that is at least partially hollow, a gas channel through the valve is provided having a relatively low flow resistance. Thus, a movable valve element can be provided which has a through opening serving as a gas channel, removing the need for gas to flow around the movable valve element, where obstructions may be present.

The base part may further comprise at least one base gas port, each base gas orifice being connected to a respective base gas port via a respective base gas channel, and the module part may further comprise at least one module gas port, each module gas orifice being connected to a respective module gas port via a respective module gas channel. Thus, using the gas ports, gas connections can be made in the base part and the module part between the gas orifices and the gas distribution network.

In an embodiment, the valve gas channel extends at least partially through the valve element in the longitudinal direction of the valve element and at least partially through the valve element in the radial direction of the valve element. That is, the valve gas channel may be open to both an end surface of the movable element when seen in its longitudinal direction and a side surface. In another embodiment, the valve gas channel may extend through the valve element entirely in the longitudinal direction of the valve element.

The resilient element may be accommodated in a cavity in the base part. In this way, the resilient element is protected against damage by external causes. In addition, the resilient element may cause little or no flow resistance for the gas flowing through the valve. The cavity may be part of a gas channel between the respective base gas orifice and the corresponding base gas port.

The resilient element may be accommodated between the movable valve element and a wall of the cavity, for example a bottom wall. That is, the resilient element may exert a resilient pressure on the movable valve element while being supported by the wall of the cavity.

The movable valve element may comprise a flange having a first side for supporting an O-ring and a second side for receiving the resilient element. In such embodiments, the resilient element may exert pressure against the second side of the flange of the movable valve element. The O-ring may be configured for sealing the cavity and may be pressed against an inner wall of the cavity by the resilient element, through the flange of the valve element.

The resilient element, which may also be referred to as elastic element, may comprise at least one coil spring. The at least one coil spring may accommodate at least a portion of the movable valve element, thus at least partially enveloping the valve element. The resilient element may comprise two, three or more coil springs. The resilient element may alternatively, or additionally, comprise at least one other spring, such as a leaf spring, or a piece of resilient or elastic material, such as rubber.

In an embodiment, a section of the valve element protrudes from the base orifice so as to contact the module part when the module part and the base part are brought together. That is, the protruding section of the movable valve element may be pressed into the base part by the module part when the base part and the module part are brought together (for example by mounting the module part on the base part). This pressing, typically against the force of the resilient element, can open the valve.

In certain embodiments, the module part comprises a dummy module orifice configured for keeping the valve of the corresponding base gas orifice closed instead of opening said valve when the base part and the module part are brought together. By providing the option of a dummy gas orifice instead of a module gas orifice, it is possible to not select a gas and to close off the corresponding base gas orifice. That is, as the dummy gas orifice is configured to not open the corresponding valve and thus to leave the valve closed, no gas will flow from the corresponding base gas orifice. The module part may thus be configured to either open a valve or leave a valve closed by being provided with an actual module gas orifice or a dummy gas orifice respectively.

When the module part comprises two or more module gas orifices, it may be configured to open the base gas orifice (or base gas orifices) of the desired gas (or gases) while leaving any other base gas orifices closed. Thus, the configuration of the module part can determine which base gas orifices are opened by bringing the base part and the module part together, and which remain closed.

Bringing the base part and the module part together may involve mounting the module part on the base part, for example. In some embodiments, the base part and the module part may for example constitute the left half and the right half of a coupling unit. In other embodiments, the base part may be mounted on top of the module part.

The dummy module orifice may comprise a recess for accommodating the protruding section of the valve element. The length of the recess can be at least the length of the protruding section of the valve element, while the width of the recess can be at least the width of the protruding section. By receiving the protruding section of the movable valve element in the recess, no pressure is exerted against the valve element and the valve remains closed.

As mentioned above, each valve may comprise a movable element accommodated in a respective base gas orifice and a resilient element for keeping the valve normally closed. The resilient element may for example be a helical spring. A portion of the movable element may protrude from the base orifice so as to contact the module part when the module part and the base part are brought together. The module part can then exert pressure on this section, which may result in pushing the movable element at least partially into the base gas orifice and thereby opening the valve.

In an embodiment, a base gas orifice may comprise a second or further O-ring for sealing against the module part. In some embodiments, the base part may consist of two sections to facilitate accommodating the movable element and the resilient element in the cavity. In such embodiments, a third O-ring may be present to seal the cavity at the joint of the base part sections.

The coupling unit may further comprise a connecting element for mechanically connecting the base unit and the module unit. The connecting element may comprise at least one bolt or screw. A single bolt or screw having a screw thread over at least part of its length may be used, a corresponding screw thread being provided in the base part. Alternatively, two or more bolts or screws may be used, or one or more clamps.

The module part may comprise a manifold, an injector and/or a detector. The module part may itself be constituted by a module of a gas chromatography systems, for example an injector module or a detector module.

Gas conduits may supply two or more different gases to the base part of the coupling unit through respective base ports. The base part may comprise two base gas orifices, although embodiments are possible in which the base part has only a single base gas orifice, or three or more base gas orifices. In a gas distribution system of a gas chromatography system, for example, a base part may be configured for receiving four different gases having different gas functions:
a carrier gas (e.g. helium, hydrogen, nitrogen, or argon/methane),
a make-up gas (e.g. helium, nitrogen or argon/methane),
a fuel gas (typically hydrogen), and
an oxidizer gas (typically air).

Depending on the function of the particular module, one or more of these gases may be required. An injector module, for example, may only require a carrier gas, while a detector module may require all four gases mentioned above. Each gas having a specific gas function may be supplied to a particular gas orifice. For example, one base gas orifice may be dedicated to carrier gas, while another base gas orifice may be dedicated to fuel gas. In other embodiments, however, the base gas orifices may not be dedicated to specific gas functions and a particular gas may be supplied to the base gas orifice using a suitable choice of gas conduits and/or a suitable arrangement of switching valves.

The present disclosure further provides a gas distribution network comprising at least one gas conduit and at least one coupling unit as described above. The gas conduits are configured for supplying gas to the coupling units, preferably to the base parts of the coupling units. It is preferred that at least two gas conduits are connected to the base part of each coupling unit to be able to supply at least two different gases to each coupling unit. The coupling units of the present disclosure can have a module part that is capable of selecting a gas from the gases supplied to the base unit by providing a module orifice at the corresponding base orifice. When the module unit is provided with a dummy orifice at a certain base orifice, the gas supplied to that base orifice is not selected while the base orifice is closed off.

The gas distribution network may further comprise at least one array of switching valves for switching gas connections between two gas conduits. Thus, the array of switching valve allows gas to be routed between gas conduits. In particular, the array of switching valves allows the supply of the various gas types to the gas conduits to be altered. The array of switching valves may be computer-controlled.

The present disclosure still further provides a coupling unit for use in the gas distribution network as described above. The coupling unit, or at least its base part, may have a length of less than 50 mm, a width of less than 50 mm, and/or a height of less than 20 mm. For example, the length of the coupling unit or its base part may be approximately 35 mm, its width may also be approximately 35 mm, while its height may be approximately 15 mm. In some embodiments, the width of the coupling unit or the base part may be smaller or greater than its length.

The present disclosure also provides a gas chromatography system comprising at least one coupling unit as described above and/or at least one gas distribution network as described above.

### BRIEF DESCRIPTION OF THE DRAWINGS

FIG. 1 schematically shows an exemplary embodiment of a gas network according to the present disclosure.

FIG. 2 schematically shows, in a perspective view, an exemplary embodiment of a gas coupling unit according to the present disclosure.

FIG. 3 schematically shows, in a cross-sectional perspective view, the embodiment of the gas coupling unit of FIG. 2 with the two parts separated.

FIG. 4 schematically shows, in a cross-sectional perspective view, the embodiment of the gas coupling unit of FIG. 2 with the two parts together.

FIG. 5 schematically shows, in a cross-sectional view, the embodiment of the gas coupling unit of FIG. 2 with the two parts together.

FIG. 6 schematically shows, in a transverse cross-sectional view, the embodiment of the gas coupling unit of FIG. 2 with the two parts together.

FIG. 7 schematically shows examples of configurations of the gas coupling unit according to the present disclosure.

FIG. 8 schematically shows a gas chromatography system in which the gas coupling unit according to the present disclosure can be utilized.

### DETAILED DESCRIPTION OF THE DRAWINGS

The present disclosure provides a gas chromatography system comprising at least one gas distribution network, at least one coupling unit, and at least one gas chromatography unit. The present disclosure also provides other analytical systems, for example systems for analytical chemistry, comprising at least one gas distribution network, at least one coupling unit, and at least one gas chromatography unit.

The gas chromatography system may comprise gas several gas chromatography units such as one or more injectors, one or more detectors, one or more chromatography columns, one or more manifolds, and optionally other components. The gas chromatography system or other analytical system may comprise a spectrometer, such as a mass spectrometer.

In particular, the present disclosure provides a gas distribution network in gas chromatography system comprising gas coupling units having valves which close automatically when a module is removed. This feature makes it very easily to temporarily or permanently remove modules, for example for maintenance purposes, or to replace modules, as it is not necessary to shut down the gas supply of the various gases.

In addition, the present disclosure provides a gas network comprising gas coupling units which allow an automatic gas selection. That is, the coupling units may be configured so as to allow to automatically select a gas source from two or more gas sources, or to select two or more gas sources from a plurality of gas sources. The coupling units comprise a base part which may be connected to a gas network and a module part which may itself be a module or component of the analytical system or which may be connected to a module or component of the analytical system by one or more gas conduits. This automatic selection can be achieved by providing module parts having one or more orifices for the desired gases and one or more dummy orifices for the undesired gases. By providing a module with a suitable combination of real orifices and dummy orifices, a selection from the available gases can be made.

A module or module part may have, for example, two orifices. If both gases provided by a base module are desired, both orifices can be real orifices. If only a single gas is desired, only one orifice is a real orifice while the other orifice is a dummy orifice. The location of the real orifice relative to the base part determines which gas is selected.

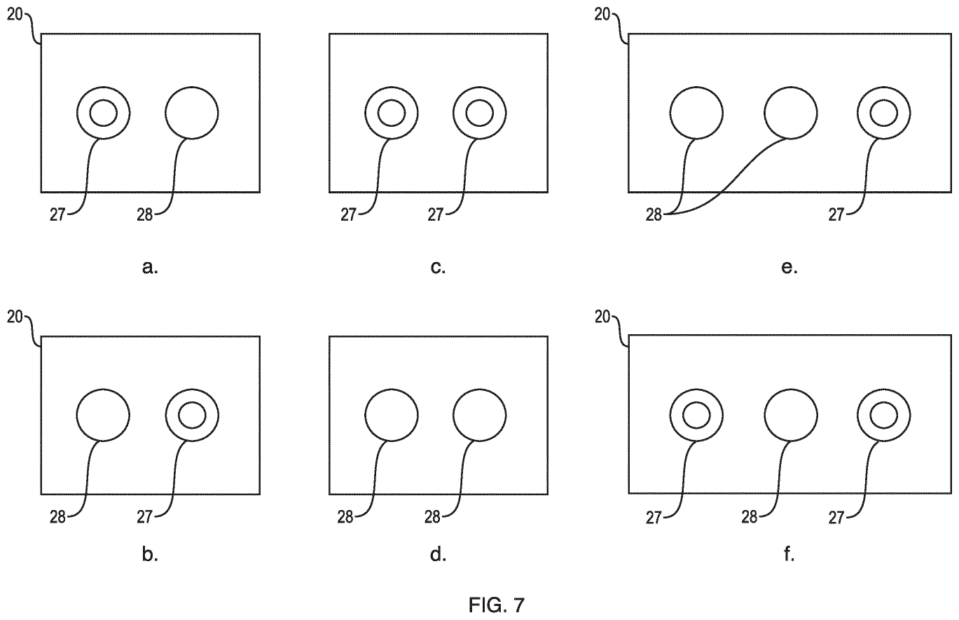

It will be understood that coupling units with only one orifice may also be used, and/or coupling units with three or more orifices. This will later be explained in more detail with reference to FIG. 7.

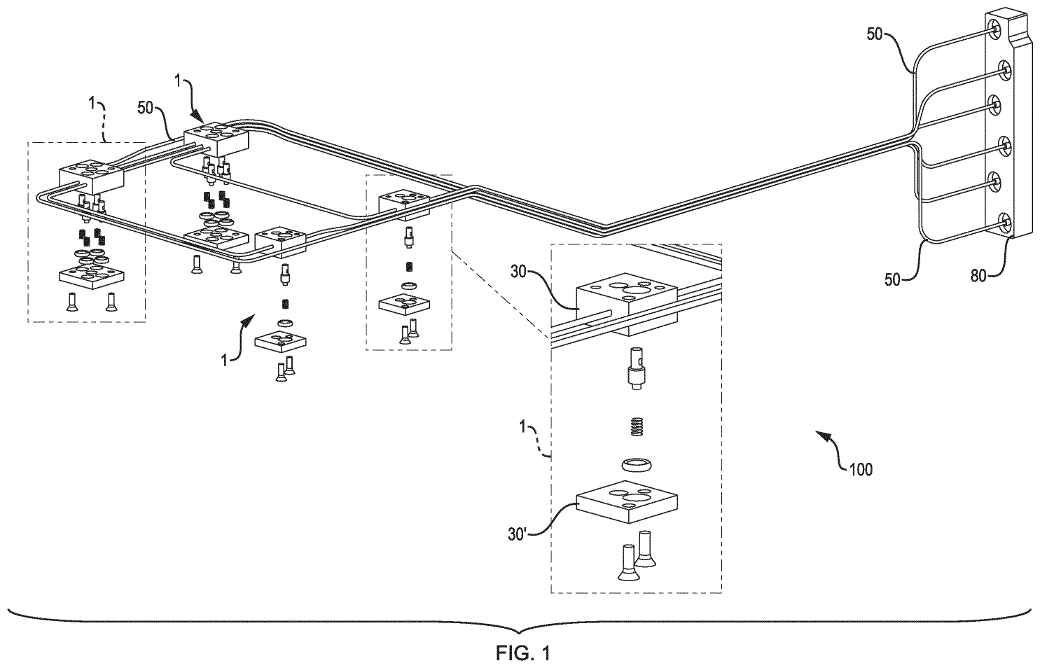

A gas network for use in an analytical system, such as a gas chromatography system, is schematically illustrated in the perspective view of FIG. 1. The gas network 100 comprises several gas coupling units 1, in the present example four gas coupling units, each shown in exploded view. Gas conduits 50 originating from a gas ports block 80 are configured for supplying gas to the various gas coupling units 1. One or more gas sources, such as a carrier gas source, a make-up gas source and/or a combustion gas source may be connected to the gas ports block.

At least four different gas functions may be used:
a carrier gas (e.g. helium, hydrogen, nitrogen, or argon/methane),
a make-up gas (e.g. helium, hydrogen, nitrogen or argon/methane),
a fuel gas (typically hydrogen), and
an oxidizer gas (typically air).

Accordingly, the single gas hydrogen, for example, may serve two different functions and may therefore be supplied using two different gas conduits.

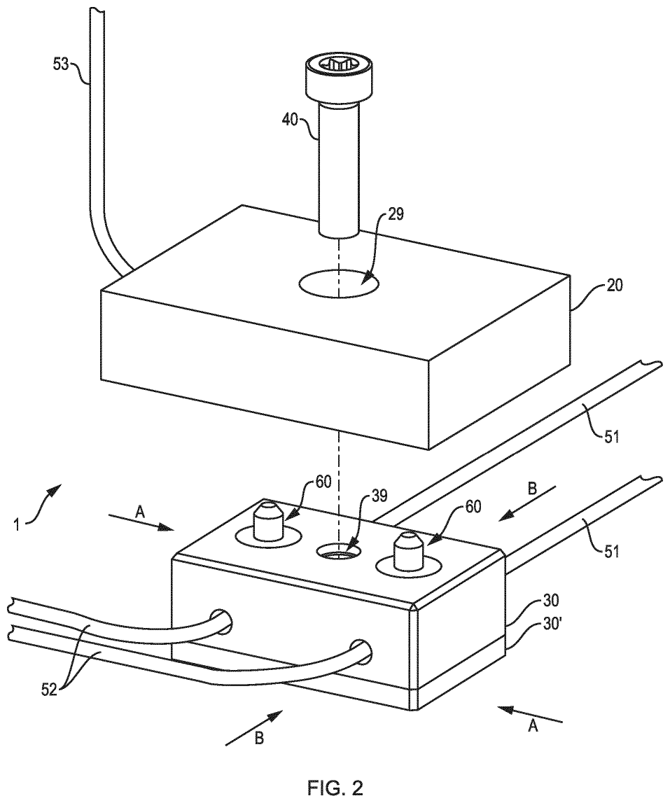

In some embodiments, one or more pumps for venting or storing waste gas may also be connected to the gas ports block 80. The gas conduits 50 may be identified as first gas conduits (51 in FIG. 2) going into coupling units and second gas conduits (52 in FIG. 2) going from coupling units. It is noted that second gas conduits may lead to further coupling units where they may be labelled first gas conduits again. Not all gases need to be supplied to all gas coupling units.

The gas conduits are connected to the base parts 30 of the gas coupling units 1. As will be explained later in more detail with reference to FIGS. 2 to 6, a module part can be connected to each base part to form a gas coupling unit 1. When used in a gas chromatography system, a relevant module, such as an injector module, a column module, or a detector module, may be integral with and/or mounted on each module part. Direct coupling of a gas conduit with a module, without using a coupling unit, is also possible.

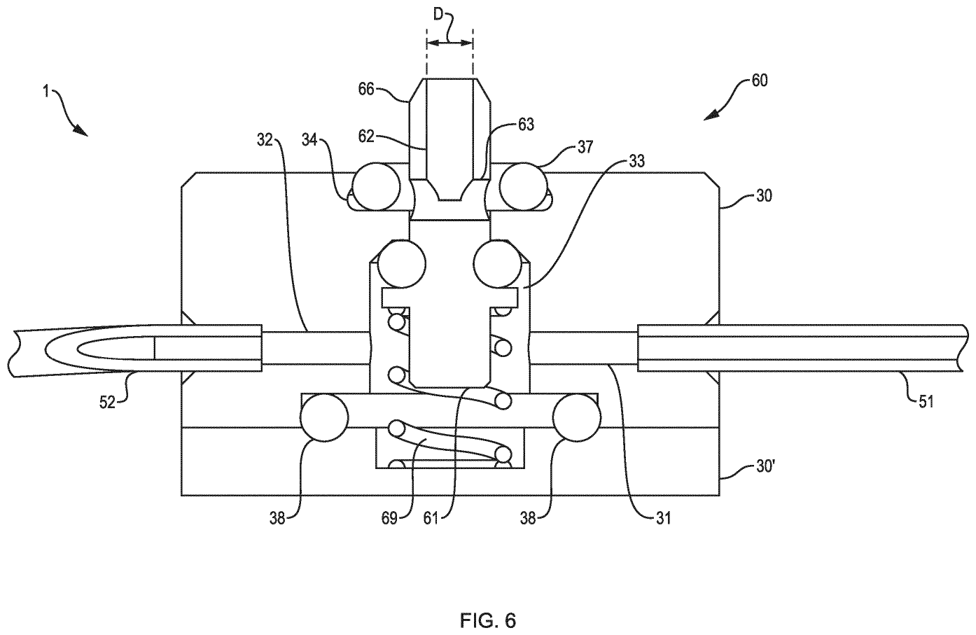

FIG. 2 shows a gas coupling unit according to the present disclosure in a perspective view. The coupling unit 1 is shown to comprise a base part 30 and a base plate 30′. In the embodiment shown, the base part 30 is provided with ports for receiving gas conduits 51 at one side and gas conduits 52 at the opposite side. The gas conduits 51 may be gas conduits from which gas flows into the coupling unit 1 while the gas conduits 52 may be gas conduits into which gas flows from the coupling unit 1. As will be shown later with reference to FIG. 6, the gas conduits 51 and 52 are connected by gas channels inside the coupling unit 1.

The base part is provided with two valves 60 which are normally closed. An opening 39 in the base part 30 may be provided with an internal screw thread for accepting the screw 40 so as to connect the module part 20 and the base part 30. The module part 20 is provided with a corresponding opening 29 through which the screw or bolt 40 may extend. Instead of a screw or bolt, another fastening mechanism may be used, such as a clamp.

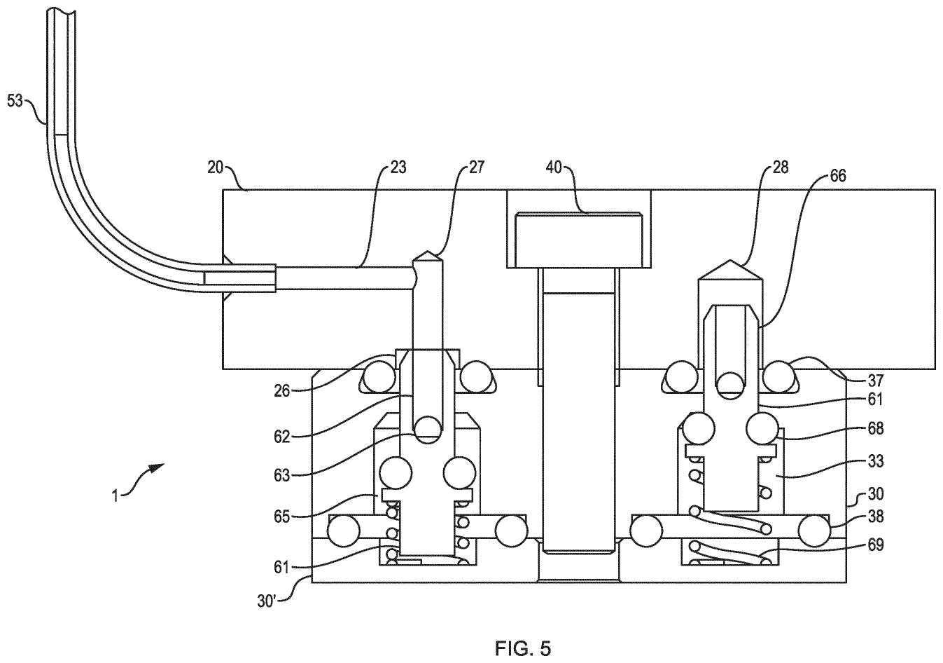

The module part 20 is provided with a port for receiving a gas conduit 53 which may lead to a device mounted on the module part 20, for example an injector. It can be seen in FIG. 2 that the base part 30 can receive two different gases, for example a carrier gas and a pressurization gas supplied via the two gas conduits 51, and that the module part 20 can have only a single gas conduit 53. The coupling unit 1 is accordingly configured for selecting one of these gases by making a gas connection with the gas having the desired gas function. In addition, the coupling unit 1 is configured so that no undesired gas flows into the module part 20. The mechanism that makes this possible is shown in the following figures, where FIG. 5 shows a cross-sectional along the line A-A in FIG. 2, while FIG. 6 shows a cross-section along the line B-B in FIG. 2.

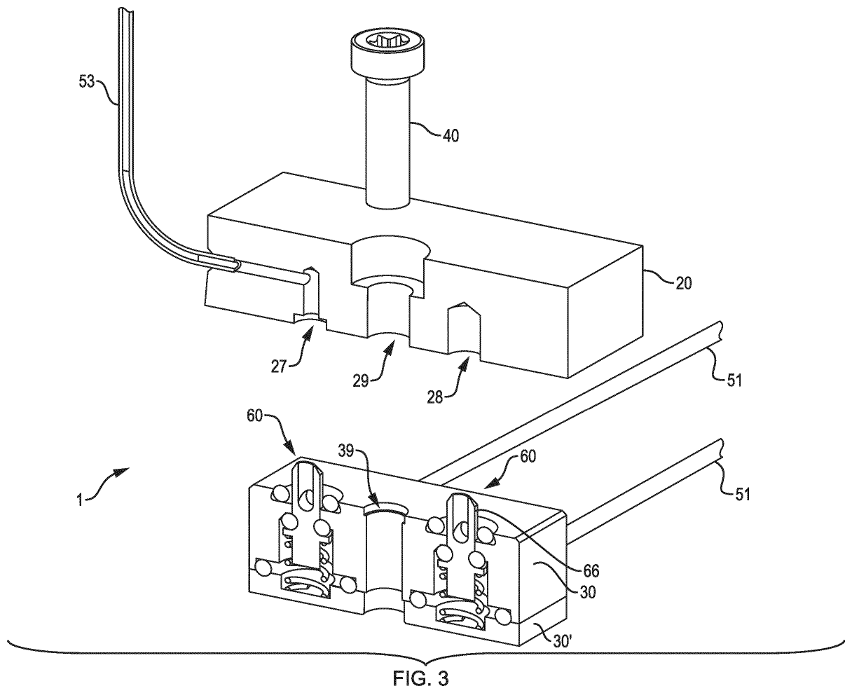

The cross-sectional perspective view of FIG. 3 also shows the base part 30 and the module part 20. The base part 30 is shown to be provided with a base plate 30′ which closes off the interior of the base part. In the embodiment shown, the valve mechanisms 60 extend beyond the upper surface of the base part. To accommodate the protruding sections 66 of the valve mechanism 60, the module part is provided with openings, in the embodiment shown an opening 27 and an opening 28. In the embodiment shown, the openings 27 and 28 are provided in the bottom surface of the module part 20 while the valve mechanisms 60 are provided in the top surfaces of the base part 30. It will be understood that the base part is shown as being below the module part only by way of example, and that the base part could be located above the module part, the valve mechanisms being arranged in the bottom surface of the base part. In other embodiments, base and module parts could be arranged side by side, having the valve mechanisms and corresponding openings arranged accordingly.

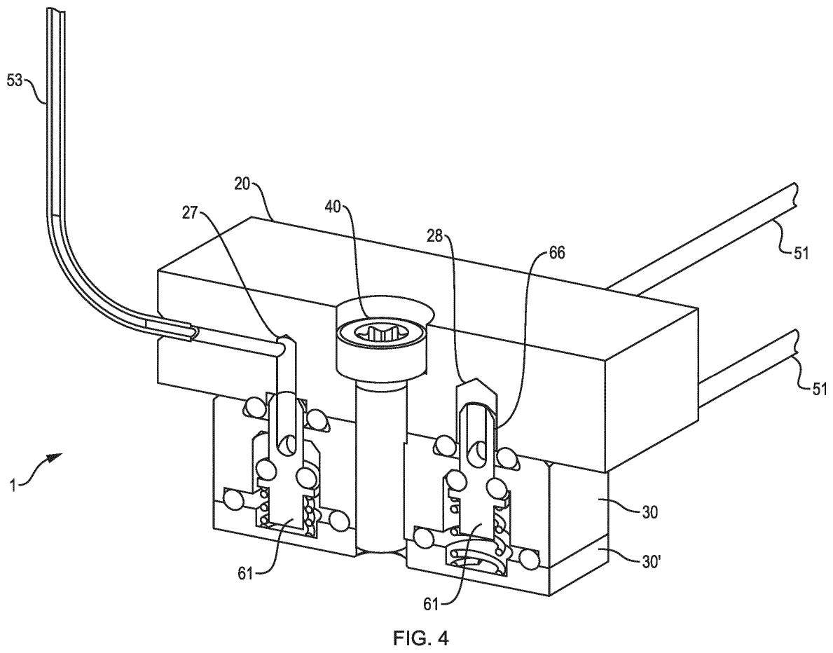

While FIG. 3 shows the base part 30 and the module part 20 while being spaced apart, FIG. 4 shows the base part 30 and the module part 20 after being brought together and attached to each other by means of the screw 40. Each valve mechanism (60 in FIG. 3) comprises a movable valve element 61, which will be explained in more detail with reference to FIGS. 5 & 6.

FIG. 5 shows a cross-sectional view along the line A-A in FIG. 2. This view shows the base part 30 and the module part 20 being attached to each other, as in FIG. 4. Two first O-rings 37 seal the base part 30 against the module part 20 at the valve mechanisms, while two second O-rings 38 seal the base part 30 against the base plate 30′ near the valve mechanisms.

In the embodiment shown, the base part 30 comprises two valve mechanisms, each comprising a movable valve element 61 and a resilient element, which is here constituted by a spring 69. Each spring 69 is arranged in a cavity 33 in the base part 30 and rests on the base plate 30′, into which the cavity 33 extends. The opposite end of each spring 69 abuts a flange 65 which extends radially from the movable valve element 61. Thus, when the base plate 30′ is mounted on the base part 30 as shown, the spring 69 exerts a pressure on the movable valve element 61, causing the valve mechanism to be normally closed.

When the base part 30 and the module part 20 are brought together so that the valves are aligned with the openings 27 and 28, both valve elements will be accommodated to some extent by the openings 27 and 28 respectively. A tip section of the valve element 61 on the left in FIG. 5 will be accommodated in a widened section 26 of the opening 27 so as to provide an improved mechanical coupling between the base part and the module part. The widened section 26 may be wide enough to accommodate the tip section of the valve element 61. The length of the widened section 26 may be a few millimeters, for example between 1 and 10 mm, in some embodiments between 4 and 6 mm, although lengths over 10 mm are also possible.

It is noted that in some embodiments the widened section 26 may be omitted. In such embodiments, the opening 27 may have a substantially uniform diameter, which may be approximately equal to the inner diameter of the movable valve element 61. In such embodiments, the valve element 61 may not be able to penetrate into the module part 20.

In most embodiments, the narrower or regular section of the opening 27 will have an inner diameter which is approximately equal to the inner diameter of the movable valve element 61. This allows a gas flow through the valve element 61, which provides a lower flow resistance than a gas flow around the valve element 61. The coupling unit 1 may be designed in such a way that a gas flow around the valve element 61 is avoided. This can be achieved by a small spacing between the valve element 61 and the narrowest part of the cavity 33, as shown in FIG. 5.

The opening or orifice 27 is configured to open the valve when the module part and base part are brought together. That is, the module part 20 presses the valve element 61 into the base part 30, thus compressing the spring 69. By doing so, the transverse section 63 of the valve element channel 62 is connected with the base element cavity 33, thus forming a gas connection between the cavity 33 and the module gas conduit 53 via the module opening 27 and the module channel 23. As will be discussed later with reference to FIG. 6, the cavity 33 can be connected with gas conduits (51 & 52 in FIG. 2), thus allowing gas to flow from a supply gas conduit (51 in FIG. 2) to the module gas conduit 53.

As described above, the valve mechanism on the left-hand side in FIG. 5 is opened by placing the module part 20 on the base part 30, for example. The valve mechanism on the right-hand side remains closed due to the presence of a wider or dummy opening or orifice 28, which is long and wide enough to accommodate at least part of the length of the valve element 61, that is, the tip section 66 which protrudes from the base part 30. As can be seen in FIG. 5, the valve element 61 on the right-hand side is not pressed into its respective cavity 33, leaving the valve mechanism closed. It can be seen that the transverse section 63 of the valve element channel 62 on the right-hand side is not connected to the respective cavity 33. In addition, the O-ring 68 resting on the flange 65 is pressed against a shoulder of the base part, thus further closing off the cavity 33.

Thus, whether a valve mechanism is opened or remains closed when the module part and base part are brought together depends on the type of orifice it is facing: a regular gas orifice having an opening 27 will open the valve, while a so-called dummy orifice having an opening 28 will leave the valve closed. By providing a module part with suitable orifices, the required gas supply can thus automatically be selected. In addition, the supply of not required gas is prevented.

It is noted that upon removing the module part from the base part, the valve mechanism facing a regular orifice will close automatically, thus preventing gas being spilled. It is further noted that in the embodiment shown, the dummy orifice 28 is not connected to any inner channels of the module part, thus further preventing a gas flow.

FIG. 6 shows a cross-sectional view along the line B-B in FIG. 2 of the base part 30. It can be seen how the supply gas conduit 51 and the return gas conduit 52 are connected in the interior of the base part via a first channel 31, a cavity 33 and a second channel 32. The transverse section 63 of the valve channel 62 is shown to extend through the width of an upper section of the valve element 61. A recess 34 in the top surface of the base part 30 accommodates the first O-ring 37, while a widened section of the cavity 33 accommodates the second O-ring 38 which seals against the base plate 30′.

The inner diameter D of the valve element channel 62 may be approximately equal to the inner diameter of the opening or orifice 27 shown in FIG. 5.

As can be seen in FIG. 6, the structure of the coupling unit 1 is simple and consists of a few components only. This makes the coupling unit reliable and easy to produce. In addition, the simple structure allows the coupling unit 1 to have small dimensions. In view of the thin gas lines that are now commonly used, the requirement for instrumentation to take up a reduced amount of space, and the need to provide a relatively large number (for example five or six) of orifices in a single coupling unit, it is important that the coupling unit can have small dimensions. In a non-limiting example, a coupling unit having five orifices can be square, measuring approximately 35 by 35 mm and having a height of approximately 15 mm (excluding the protruding tip section 66 of the valve). The inner diameter D of the valve channel 62 may be approximately 2 mm. It can thus be seen that some prior art valve designs would be difficult to manufacture with these small dimensions. The simple design of the present disclosure, having a minimum number of components, allows small coupling units to be manufactured economically.

In addition, the coupling unit of the present disclosure offers an improved easy of handling compared to prior art designs.

As discussed above, the module part may comprise two gas orifices, one module gas orifice and one dummy gas orifice. This allows one gas from two gases to be selected and to flow into the module part. In some embodiments, both gas orifices may be module gas orifices, thus selecting both available gases. In other embodiments, both gas orifices may be dummy gas orifices, thus selecting none of the available gases. In still other embodiments, the module part may comprise only a single gas orifice, which may be either a module gas orifice or a dummy gas orifice. In yet other embodiments, the module part may comprise three or more gas orifices, each of which may be either a module gas orifice or a dummy gas orifice, as desired.

It is noted that a particular gas (such as helium) or a particular gas function (such as carrier gas) may always be supplied to the same base orifice, unless a gas switching network is used which allows the gases fed into the different gas conduits (50 in FIG. 1) to be changed. Thus, the carrier gas will normally be supplied to the same base orifice, if applicable. If a carrier gas is supplied to a base orifice, a module may or may not select the carrier gas by having a real module gas orifice or a dummy gas orifice respectably.

FIG. 7 schematically shows examples of configurations of the gas coupling unit according to the present disclosure. In the embodiments described above, the module part 20 of the coupling unit has one real orifice or opening 27 and one dummy orifice or opening 28, as shown at a. in FIG. 7. This configuration causes the module to open one valve (on the left-hand side in the drawings) and leave the other valve (on the right-hand side in the drawings) closed. This configuration could be reversed, as shown at b. in FIG. 7, where a dummy opening 28 is provided on the left-hand side and a real opening 27 on the right-hand side. It is noted that although the module parts 20 are shown in FIG. 7 as symmetric part, they may in practice not be symmetric and may fit on the base part in a single way only. It is further noted that the coupling units of FIG. 7 are all rectangular, but that round, oval, square, or polygonal designs are also possible.

At c. in FIG. 7, both openings are real openings 27, implying that gas may flow through both opening when the module part is mated with a base part. At d. in FIG. 7, both openings are dummy openings 28, implying that no gas will flow through any of the openings when the module part is mated with a base part. As illustrated at e. and f. in FIG. 7, the number of openings is not limited to two and embodiments are possible in which a module unit 20 has only a single opening, or three openings as illustrated at e. and f., or four or more openings. When three openings are used, two of them can be dummy openings 28 as illustrated at e., or two of them can be real openings as illustrated at f. The order of the real and dummy openings can be chosen so as to accommodate the requirements of the respective module. Although the arrangements at e. and f. are linear, the disclosure is not so limited and other arrangements of openings are possible, for example triangular arrangements.

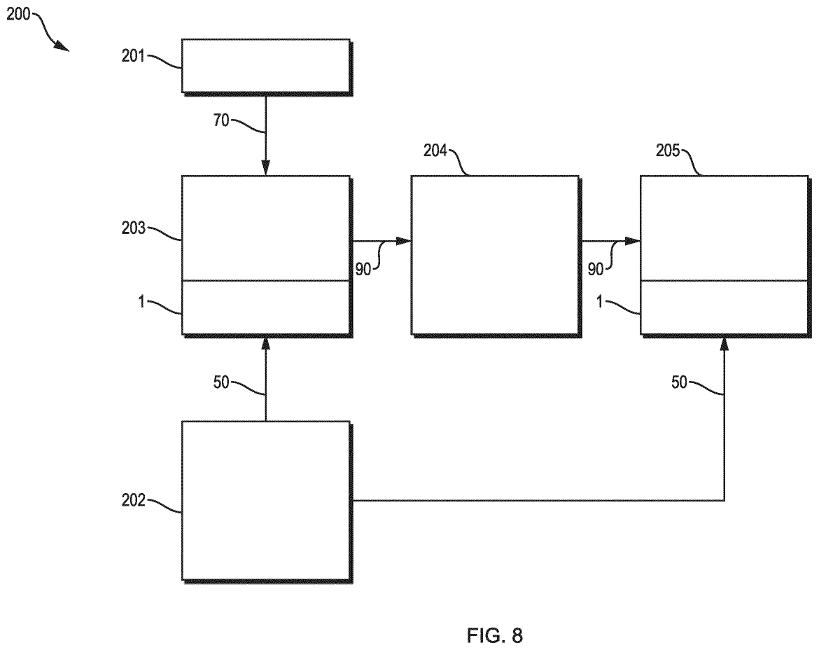

FIG. 8 schematically shows an exemplary gas chromatography system in which the gas coupling units according to the present disclosure can be utilized. The exemplary gas chromatography (GC) system 200 is shown to comprise several gas chromatography units, such as a sampling device 201, a gas supply 202, an injector 203, a GC column 204 and a detector 205. The gas coupling units 1 connect the gas supply 202 with the injector 203 and the detector 205. The sampling device 201 can introduce the sample to be analyzed into the injector 203, as represented by the arrow 70. Typically, this is done using a syringe, such as a micro syringe. Fluid connections 90 connect the injector 203 to the column 204 and, in turn, the column 204 to the detector 205. The connections 90 can be constituted by suitable column fittings.

The gas supply 202 is connected to a gas network comprising gas conduits 50 and at least one coupling unit 1 as described above. In the example shown, the injector unit 203 can receive both the pressurization gas and the carrier gas through a coupling unit 1. Similarly, the detector 205 can receive make-up gas and/or other gases through another coupling unit 1. Thus the injector unit 203 may comprise a module unit (20 in FIG. 2) or may be mounted on a module unit. Similarly, the detector unit 205 may comprise a module unit (20 in FIG. 2) or may be mounted on a module unit. Placing the injector unit 203 and the detector unit 205 on the base unit of their respective coupling unit 1 can cause at least one gas orifice in each coupling unit to open. By using a suitable layout of the gas orifices, only a gas orifice providing a gas required by the respective unit may be opened.

Embodiments of the present disclosure provide a coupling unit for coupling gas conduits in a gas distribution network, the coupling unit comprising a base part and a module part,
the base part comprising at least one base gas orifice and at least one base gas port, each base gas orifice being connected to a respective base gas port via a respective base gas channel,
the module part being provided with at least one module gas orifice and at least one module gas port, each module gas orifice matching a corresponding base gas orifice and each module gas orifice being connected to a respective module gas port via a respective module gas channel,
each base gas orifice being provided with a respective valve which is normally closed,
each module gas orifice being configured for opening the valve of the corresponding base gas orifice when the base part and the module part are brought together, and
each valve comprising a movable valve element accommodated in a respective base gas orifice and a resilient element for keeping the valve normally closed.

At least one valve element may be at least partially hollow so as to provide a valve gas channel through the respective valve element. However, in some embodiments solid valve elements may be used.

The coupling unit, or at least the base part, may have a length of less than 50 mm, preferably less than 40 mm, for example approximately 35 mm, approximately 30 mm or approximately 25 mm. Similarly, the coupling unit, or at least the base part, may have a width of less than 50 mm, preferably less than 40 mm, for example approximately 35 mm, approximately 30 mm or approximately 25 mm. The base part may further have a height of less than 25 mm, preferably less than 20 mm, for example approximately 15 mm or approximately 10 mm.

It will be understood by those skilled in the art that the present disclosure is not limited to the embodiments described above and that many additions and modifications may be made without departing from the scope of the disclosure as defined by the appending claims.

1. A gas chromatography system comprising:
at least one gas distribution network,
at least one coupling unit, and
at least one gas chromatography unit,
wherein the at least one coupling unit comprises a base part and a module part, the base part being connected to the at least one gas distribution network and the module part being connected to the at least one gas chromatography unit,
wherein the base part and the module part can be removably coupled, and
wherein the base part comprises at least one valve,
characterized in that the module part is configured for operating the at least one valve, so as to
automatically establish a gas connection when the base part and the module part are coupled, and
automatically interrupt the gas connection when the base part and the module part are decoupled.

2. The gas chromatography system according to claim 1, wherein
the base part defines at least one base gas orifice,
the module part defines at least one module gas orifice, each module gas orifice matching a corresponding base gas orifice,
each base gas orifice being provided with a respective valve which is normally closed,
each module gas orifice being configured for opening the valve of the corresponding base gas orifice when the base part and the module part are brought together,
each valve comprising a movable valve element accommodated in a respective base gas orifice and a resilient element for keeping the valve normally closed, and
each valve element being at least partially hollow so as to provide a valve gas channel through the respective valve element.

3. The gas chromatography system according to claim 2, wherein
the base part further comprises at least one base gas port, each base gas orifice being connected to a respective base gas port via a respective base gas channel,
the module part further comprises at least one module gas port, each module gas orifice being connected to a respective module gas port via a respective module gas channel.

4. The gas chromatography system according to claim 2, wherein the valve gas channel extends at least partially through the valve element in its longitudinal direction and at least partially through the valve element in its radial direction.

5. The gas chromatography system according to claim 2, wherein the resilient element is accommodated in a cavity in the base part.

6. The gas chromatography system according to claim 5, wherein the resilient element is accommodated between the valve element and a wall of the cavity.

7. The gas chromatography system according to claim 5, wherein the valve element comprises a flange having a first side for supporting an O-ring and a second side for receiving the resilient element.

8. The gas chromatography system according to claim 7, wherein the O-ring is configured for sealing the cavity.

9. The gas chromatography system according to claim 2, wherein the resilient element comprises at least one coil spring.

10. The gas chromatography system according to claim 2, wherein a section of the valve element protrudes from the base gas orifice so as to contact the module part when the module part and the base part are brought together.

11. The gas chromatography system according to claim 2, wherein the module part defines a dummy module orifice configured for keeping the valve of the corresponding base gas orifice closed instead of opening said valve when the base part and the module part are brought together.

12. The gas chromatography system according to claim 11, wherein the dummy module orifice comprises a recess for accommodating a protruding section of the valve element.

13. The gas chromatography system according to claim 1, wherein the base part defines at least two base gas orifices.

14. The gas chromatography system according to claim 1, wherein the base part defines at least four base gas orifices.

15. The gas chromatography system according to claim 11, wherein the module part defines at least one module orifice and at least one dummy orifice.

16. The gas chromatography system according to claim 1, wherein each base gas orifice is provided with at least one further O-ring configured for sealing against a module part.

17. The gas chromatography system according to claim 16, further comprising a connecting element for mechanically connecting the base part and the module part.

18. The gas chromatography system according to claim 17, wherein the connecting element comprises a bolt.

19. The gas chromatography system according to claim 1, wherein the module part comprises a manifold, an injector and/or a detector.

20. The gas distribution network according to claim 19, further comprising at least one array of switching valves for switching gas connections between two gas conduits.

21. The gas distribution network according to claim 20, wherein the array of switching valves is computer controlled.

22. A coupling unit for use in the gas distribution network according to claim 2,
wherein the coupling unit comprises a base part and a module part, the base part being connected to the gas distribution network and the module part being connected to the at least one gas chromatography unit,
wherein the base part and the module part can be removably coupled, and
wherein the base part comprises at least one valve,
characterized in that the module part is configured for operating the at least one valve, so as to
automatically establish a gas connection when the base part and the module part are coupled, and
automatically interrupt the gas connection when the base part and the module part are decoupled.

23. The coupling unit according to claim 22, wherein
the base part defines at least one base gas orifice,
the module part defines at least one module gas orifice, each module gas orifice matching a corresponding base gas orifice,
each base gas orifice being provided with a respective valve which is normally closed,
each module gas orifice being configured for opening the valve of the corresponding base gas orifice when the base part and the module part are brought together,
each valve comprising a movable valve element accommodated in a respective base gas orifice and a resilient element for keeping the valve normally closed, and
each valve element being at least partially hollow so as to provide a valve gas channel through the respective valve element.

24. The coupling unit according to claim 22, wherein the valve gas channel extends at least partially through the valve element in its longitudinal direction and at least partially through the valve element in its radial direction.

25. The coupling unit according to claim 22, wherein the resilient element is accommodated in a cavity in the base part.

26. The coupling unit according to claim 25, wherein the resilient element is accommodated between the valve element and a wall of the cavity.

27. The coupling unit according to claim 22, wherein the valve element comprises a flange having a first side for supporting an O-ring and a second side for receiving the resilient element.

28. The coupling unit according to claim 27, wherein the O-ring is configured for sealing a cavity in the base part.

29. The coupling unit according to claim 22, wherein the resilient element comprises at least one coil spring.

30. The coupling unit according to claim 22, wherein a section of the valve element protrudes from the base gas orifice so as to contact the module part when the module part and the base part are brought together.

31. The coupling unit according to claim 22, wherein the module part defines a dummy module orifice configured for keeping the valve of the corresponding base gas orifice closed instead of opening said valve when the base part and the module part are brought together.

32. The coupling unit according to claim 31, wherein the dummy module orifice comprises a recess for accommodating a protruding section of the valve element.

33. The coupling unit according to claim 22, wherein the base part defines at least two base gas orifices.

34. The coupling unit according to claim 22, wherein the base part defines at least four base gas orifices.

35. The coupling unit according to claim 31, wherein the module part defines at least one module orifice and at least one dummy orifice.

36. The coupling unit according to claim 22, wherein the base part has a length of less than 50 mm, a width of less than 50 mm, and/or a height of less than 20 mm.
